(19) United States
(12) Patent Application Publication
(10) Pub. No.: US 2018/0119540 A1
(43) Pub. Date: May 3, 2018

(54) FLUID LEVEL SENSING

(71) Applicant: Oleum Technology LLC, New York, NY (US)

(72) Inventor: Ender de Jesus Boscán Castillo, Pichincha (EC)

(21) Appl. No.: 15/796,559

(22) Filed: Oct. 27, 2017

Related U.S. Application Data
(60) Provisional application No. 62/415,789, filed on Nov. 1, 2016.

(51) Int. Cl. E21B 47/04; G01F 23/296; E21B 34/02

(52) U.S. Cl. CPC E21B 47/042; E21B 47/06; E21B 34/02; G01F 23/2962

(57) ABSTRACT

Systems, techniques, and apparatus are provided for fluid level sensing. An instruction to open may be transmitted to a smart valve that may be between an annulus of a well and a head unit. An instruction to discharge gas into the annulus of the well may be transmitted to a head unit. Sound wave data generated by a microphone of the head based on a sound wave propagated through gas in the annulus of the well may be received. A level of fluid over a pump in the well may be determined based on the sound wave data.

### BACKGROUND

Various techniques may be used to increase the output of an oil well. These techniques may rely on data collected by various sensors about various aspects of the oil well. Sensors may be deployed into an oil well in order to monitor the oil well and collect data that may be used to increase the output of the oil well. Some specialized sensors may be expensive, limiting their deployment in oil wells and the ability to implement certain production-enhancing techniques to increase the output of oil wells where the specialized sensors are not deployed.

### BRIEF SUMMARY

According to implementations of the disclosed subject matter, an instruction to open may be transmitted to a smart valve that may be between an annulus of a well and a head unit. An instruction to discharge gas into the annulus of the well may be transmitted to a head unit. Sound wave data generated by a microphone of the head based on a sound wave propagated through gas in the annulus of the well may be received. A level of fluid over a pump in the well may be determined based on the sound wave data.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an exemplary device in accordance with the disclosed subject matter.

FIG. 2 shows an exemplary device in accordance with the disclosed subject matter.

FIG. 3 shows an exemplary apparatus in accordance with the disclosed subject matter.

FIG. 4 shows an exemplary system in accordance with the disclosed subject matter. matter.

FIG. 5A shows an exemplary system in accordance with the disclosed subject matter.

FIG. 5B shows an exemplary system in accordance with the disclosed subject matter.

FIG. 5C shows an exemplary system in accordance with the disclosed subject matter.

FIG. 7 shows a computer according to an embodiment of the disclosed subject matter.

FIG. 8 shows a network configuration according to an embodiment of the disclosed subject matter.

### DETAILED DESCRIPTION

Various types of pumps may be used in a well such as, for example, a production oil well. A pump used in a well may be, for example, a progressive cavity pump, a mechanical pump, or an electro-submersible pump. The pump may be located towards the bottom of a production tubing in the well, and may be covered by some level of fluid. The fluid may be, for example, a mixture of oil, water, and other substances. To determine the fluid level over the pump within a well, free gas produced by the well may be gathered, compressed and injected back into the well, creating a sound wave within the well. The sound wave may rebound off of the surface of the fluid covering the pump and return to a sensor positioned above the fluid level. The travel time of the wave from the valve to the fluid surface and back to the sensor may be determined. The travel time and the speed of the sound wave may be used to determine the fluid level within the well over the pump. Knowledge of the fluid level over the pump within the well may be used in the implementation of various techniques that may increase the production of the well.

A well, such as a production oil well, may include production tubing and an annulus around the production tubing, between the production tubing and the casing of the well. The production tubing may include a suitable pump which may be used to lift oil out of the well through the production tubing to a production line at the surface. Gases may gather within the annulus of the well, and may rise to the top of the well, which may be capped. The top of the well may include various valves, hoses, piping, and tubing, which may allow for the capture or discharge of the gases. Some production wells may include multiple annuluses.

A head unit may be attached mechanically to the annulus of a well. The head unit may be attached to the annulus through a mechanical connection to a suitable number of smart valves. For example, a smart valve may be positioned on a pipe, tube, or hose connecting the annulus of the well to the head unit. Free gas flowing up the annulus of the well may be routed to a compression chamber attached to the head unit. The pressure of the flowing gas may be used to compress the gas within the compression chamber. The smart valve may be opened in order to allow the dispersion a suitable amount of gas, for example, a small amount, from the compression chamber to create a sound wave that may travel inside the well. The head unit may also include a microphone. The head unit may be connected directly, or remotely, for example, through a wide area network or satellite link, to a suitable computing device. Sound data gathered by the microphone based on detected sound waves may be transmitted from the head unit to the computing device. The computing device may also control the smart valve, for example opening and closing the smart valve, and may control the discharge of gas into the well.

A pressure control system may be attached mechanically to the head unit and to the production line of the well. The pressure control system may include high pressure connections with a dual sensor for determining temperature and pressure and a fast-acting pressure control valve, which may be a smart valve. The fast-acting pressure control valve may be, for example, on a pipe, tube, or hose connecting the pressure control system to a production line, which may connect to the production tubing within the well and may include separate lines to carry liquid brought up the production tubing, such oil, and gases, such as the gas from the annulus of the well. The pressure control system may be connected to the computing device, directly, or remotely, for example, through a wide area network or satellite link. The pressure control system may transmit data from the pressure sensor and temperature sensor to the computing device.

The computing device may be any suitable computing device, such as, for example, a desktop, laptop, tablet, smartphone, or server system, and may be located proximate to the well, or may be located remotely. The computing device may control smart valves, and may receive data from the head unit and the pressure control system. For example, the computing device may receive temperature and pressure data from the pressure control system, and may operate the fast-acting pressure control valve of the pressure control system that connects the pressure control system to the production line. For example, the computing device may close the fast-acting pressure control valve to control the pressure of the flow at the bottom of the well when a variation in temperature is detected in the production line, for example, with the temperature increasing upwards of 5%, which may be reflected in an increase of the well's water cut, which may the percentage of water by mass in the fluid being extracted from the well, by 10%.

The computing device may control the smart valves which connect the head unit to the annulus of the well, may control the discharge of gas from the head unit, and may receive sound data collected by the microphone of the head unit. For example, the computing device may cause the smart valve of the head unit, or another smart valve, for example, attached to the compressions chamber, to open in order to disperse a suitable amount of gas, for example, a small amount, from the compression chamber to create a sound wave that may travel inside the well. The sound wave may rebound within the well, for example, rebounding off of the top surface of fluid in the well. The rebounding of the sound wave may be captured, for example, by the microphone attached to the head unit, or by any suitable sensor adapted to detect changes in pressure, such as a pressure sensor, as sound wave data. The data on the rebounding of the sound wave may be filtered and analyzed by the computing device to determine values for aspects of the well in real time, for example, once every 15 seconds. The aspects of the well may be, for example, pressure of input to the pump (PIP), fluid over the pump (FOP), pressure flowing at the bottom of the well (PWF), level of fluid free of gas on the pump (FGL), the dynamic level of fluid (DLF), analyzation of the water that makes up the water cut by temperature, the curve of influx of the well (IPR), among other aspects of the well. The fluid over the pump may be the level of fluid, such as oil, water, or a mixture thereof, that covers the pump, and may be determined based on the sound wave data captured during the rebounding of the sound wave. The other aspects of the well may be determined based on any suitable data, including, for example, data from the temperature and pressure sensors of the pressure control system as well as sound wave data captured during the rebounding of the sound wave.

The discharging of any amount of gas by the head unit may create a sound wave that travels within the well. The sound wave may create areas of low pressure or rarefication within the gases in the annulus of the well, as the sound wave propagates through the gases. The microphone of the head unit may be used to detect the rebounding of the sound wave within the well, including the rebounding of the wave within and off of the fluid in the well, such as the surface of the fluid over the pump. The fluid may be, for example, oil, water, or a mixture thereof. The rebounding of the sound wave may be recorded by the microphone of the head unit. Noise may be filtered from the data recorded by the microphone, and the data may be adjusted. The data recorded by the microphone may be used to calculate the speed of propagation of the sound wave within the well. The speed of propagation may then be used to determine the travel time of the sound wave, which may be the amount of time taken for the sound wave to rebound off the surface of the top of the fluid in the well. The travel time may be used along with the specific gravity of the gas released to create the sound wave to determine level of fluid over the pump in the well.

The determined level of fluid over the pump in the well may be used in any suitable manner. For example, the level of fluid over the pump may be monitored at suitable intervals to determine when the maximum pressurization of the well has been reached under certain conditions, such as, for example, during pressurization of the annulus through the closing of discharge valves for free gas. The conditions under which maximum pressurization occurs may be used to control the release of pressurized free gas back into the well, and the level of fluid over the pump may continue be monitored at suitable intervals to ensure that the desired pressurization of the well is maintained. This may result in more efficient oil production by the well.

FIG. 1 shows an exemplary device in accordance with the disclosed subject matter. A head unit 100 may be made of any suitable materials for containing gas from the annulus of an oil well. The head unit may include a microphone, and a connector 110. The connector 110 may mechanically connect the head unit 100 to the annulus of a well. A smart valve may be attached between the connector 110 and the annulus of the well, and may control the flow of gas between the annulus of the well and the head unit 100.

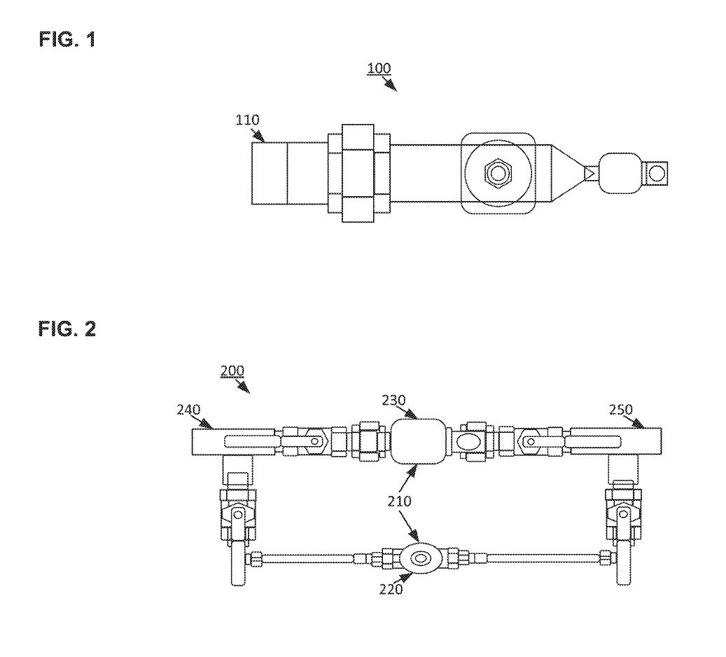

FIG. 2 shows an exemplary device in accordance with the disclosed subject matter. A pressure control system 200 may be made of any suitable materials for containing gas from the annulus of an oil well. The pressure control system 200 may include a dual sensor 210, a connector 240, and a connector 240. The dual sensor 210 may include, for example, a temperature sensor 220 and a pressure sensor 230. The connector 240 may mechanically connect the pressure control system 200 to the head unit 100, and the connector 250 may mechanically connect the pressure control system 200 to a production line of the well. The temperature sensor 220 may be any suitable sensor for detecting the temperature of liquid or gas. The pressure sensor 230 may be any suitable sensor for detecting the pressure of a liquid or gas.

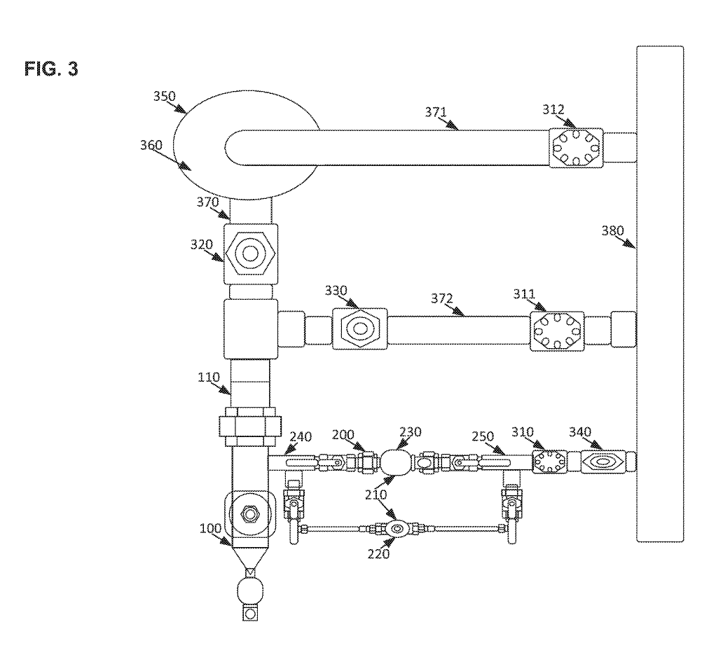

FIG. 3 shows an exemplary apparatus in accordance with the disclosed subject matter. The pressure control system 200 may be mechanically connected to the head unit at the connector 240. The connector 240 may allow for substances, including gases, to flow between the head unit 100 and the pressure control system 200. The head unit 100 may be mechanically connected to an annulus 360 of a well 350. The well 350 may be, for example, a production oil well. The annulus 360 may be the area of the well 350 between the production tubing and the casing of the well 360. The annulus 360 of the well may be capped. A smart valve 320 may be connected between the connector 110 of the head unit 100 and the annulus 360. For example, a connector 370 may exit the annulus 360 and be connected to the smart valve 320 which may then be connected to the connector 110.

Production tubing 371 may exit the well 350 and may be connected to a production line 380. The production tubing 371 may carry substances, such as liquids, for example, oil, and gas, up from the well 350 to the production line 380. The production tubing 371 may be made of any suitable materials, and have any suitable configuration, including any suitable number of separate lines for carrying substances. The production line 380 may carry substances, such as oil, away from the well 350 to be stored. The production line 380 may be made of any suitable materials, and have any suitable configuration. The production line 380 may include separate lines, such as piping, tubing, or hoses, for different substances. For example, the production line 380 may include separate lines for liquids brought up through the production tubing 371, and for gases routed to the production line 380 from the annulus 360. Gases may be routed to the production line 380 through a smart valve 330 and connector 372 that may be connected in between the smart valve 320 and the connector 110 of the head 100. For example, when the smart valve 320 is open and the smart valve 330 is open, gases from the annulus may be routed to the head unit 100, and to the production line 380 through connector 372. The connector 372 may be made of any suitable materials, and may be, for example, piping, tubing, or hoses. Closing the smart valve 330 while the smart valve 320 is open may route gases only to the head unit 100. The production line 380 may act as an exit for gases from the annulus 360, carrying the gases away from the well 350. The smart valve 330 may act as a discharge valve for the gases from the annulus 360. A smart valve 340 may be connected in between the connector 250 of the pressure control system 200 and the production line 380. The smart valve 340 may be a fast acting pressure control valve. When the smart valve 340 is open, the pressure sensor 230 and the temperature sensor 220 of the dual sensor 210 may be exposed to gas carried in a line of the production line 380, and may be able to take pressure and temperature readings.

A number of check valves, such as check valves 310, 311, and 312, may be included at various location, for example, between the production tubing 371 and the production line 380, between the connector 372 and the production line 380, and between the pressure control system 200 and the smart valve 340. The check valves 310, 311, and 312 may ensure that substances flow in the proper direction, for example, away from the well 350. There may be no check valve between the head unit 100 and the annulus 360, allowing the head unit 100 to cause gas to flow back into the annulus 360.

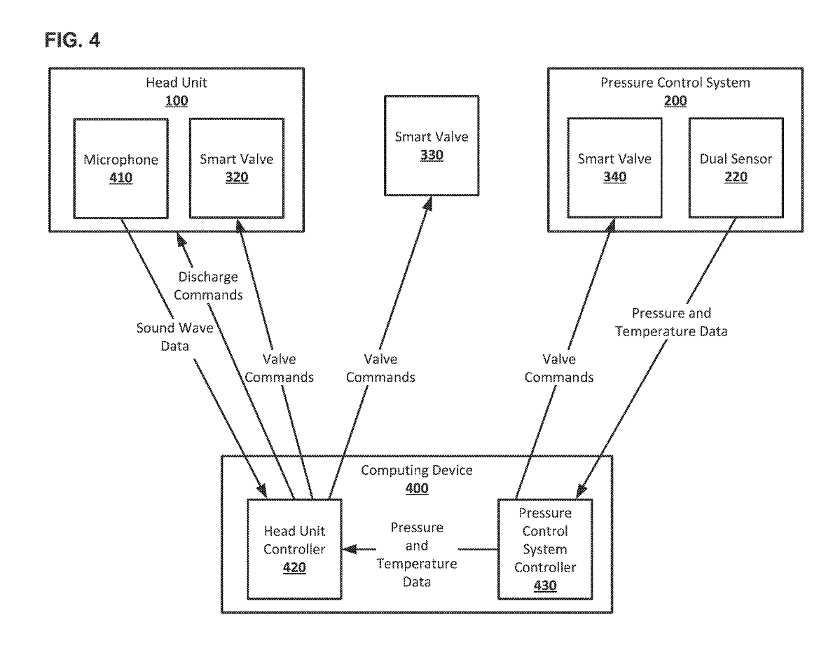

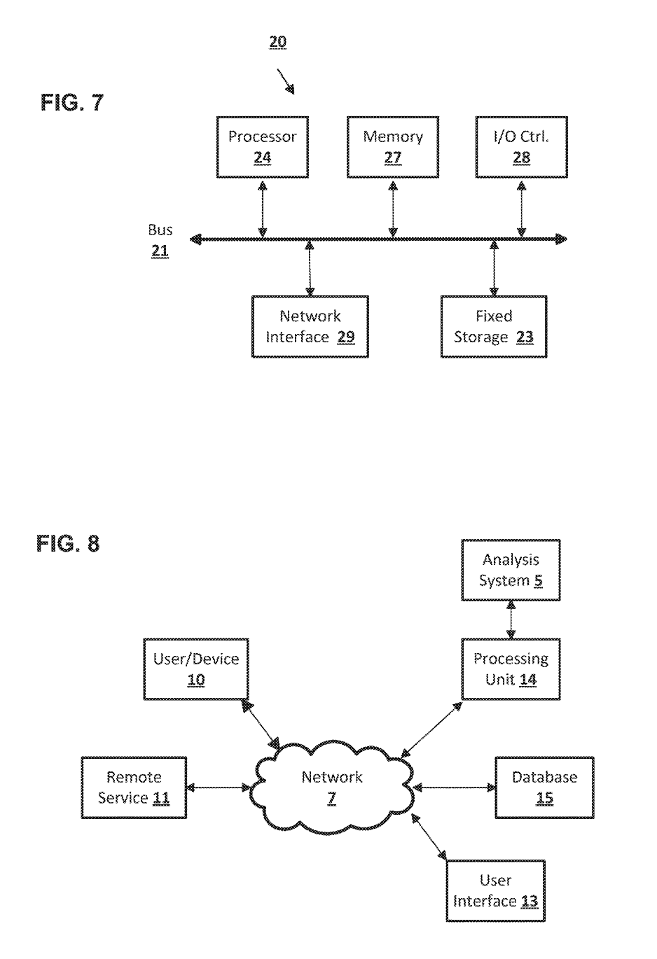

FIG. 4 shows an exemplary system in accordance with the disclosed subject matter. The head unit 100 and pressure control system 200 may communicate with a computing device 400. The computing device 400 may be any suitable computing device, such as, for example, a computer 20 as described in FIG. 7, for implementing a head unit controller 420 and a pressure control system controller 430. The computing device 400 may be a single computing device, or may include multiple connected computing devices, and may be, for example, a laptop, a desktop, an individual server, a server farm, or a distributed server system, or may be a virtual computing device or system, or may be a special purpose computing device. The computing device 400 may also control smart valves, such as the smart valves 320, 330, and 340

The computing device 400 may communicate with the head unit 100 and the pressure control system 200, and the smart valves 320, 330, and 340, in any suitable manner, such as, for example, via a direct wired or wireless link, or a wide area network, cellular, or satellite link. For example, the computing device 400 may be located near the well 350, and may be directly connected to the dual sensor 210 of the pressure control system 200 and to a microphone 410 of the head unit 100 through wires or through wireless transmitters using any suitable form of wireless communication. The computing device 400 may also be located remotely, and may receive data from the dual sensor 210 and microphone 410 as relayed, for example, through a wide area network from the site of the well 350.

The computing device 400 may include a head unit controller 420. The head unit controller 420 may be any suitable hardware and software of the computing device 400 for controlling the head unit 100, including sending discharge commands to the head unit 100, and controlling the smart valve 320 that connects the head unit 100 to the annulus 360. For example, the head unit controller 420 may send instructions that cause the smart valve 320 to open to allow gas flowing out the annulus 360 to reach the head unit 100, and to compress in the chamber attached the head unit 100. The head unit controller 420 may send instructions that cause the smart valve 320 to close, for example, to allow pressurization of the gas within the annulus 360. The head unit controller 420 may also send instructions that cause the head unit 100 to discharge compressed gas from the chamber into the annulus 360 to create a sound wave that may be detected by the microphone 410 and turned into sound wave data. The head unit 100 may discharge that gas from the chamber into the annulus 360 in any suitable manner. For example, the smart valve 320 may be opened to allow for the discharge using a discharge mechanism of the head unit 100, or another smart valve of the head unit 100, for example, connected between the chamber and the annulus 360, may be instructed to open briefly and then close to discharge gas into the annulus 360, for example using the pressure of the gas in the chamber to cause the discharge. The head unit controller 420 of the computing device 400 may instruct the discharge from the head unit 100 at any suitable time, and at any suitable interval. For example, discharge commands may be sent once every 15 seconds during a data gathering phase, which may last for any suitable length of time.

The head unit controller 420 may receive sound wave data from the microphone 410. The microphone 410 may generate the sound wave data whenever the head unit 100 discharges gas into the annulus 360, as the gas may create a sound wave which may rebound off the surface of any fluid in the well and be recorded by the microphone 410. In some implementations, the gas may also transmit the sound wave through the fluids in the well, and the sound wave may rebound off the bottom of the well through the fluids and back up through the gas in the annulus 360.

The computing device 400 may include a pressure control system controller 430. The pressure control system controller 430 may be any suitable hardware and software of the computing device 400 for controlling the pressure control system 200, including sending controlling the smart valve 340 that connects the pressure control system 200 to the production line 380.

The pressure control system controller 430 may receive pressure and temperature data from the dual sensor 210 of the pressure control system 200. For example, when the smart valve 340 is open, the dual sensor 210 may sense the pressure and temperature of gas from the well 350 being carried by the production line 380, which may be sent to the pressure control system controller 430. When the smart valve 320 is open, the dual sensor 210 may sense the pressure and temperature of gas from the well 350 that moves through the connector 370, the smart valve 320, and the connector 110 of the head unit 100.

The computing device 400 may also control the smart valve 330, which may connect the annulus 360 to the production line 380 through the smart valve 320. For example, the computing device 400 may send instructions that cause the opening of both the smart valve 320 and the smart valve 330 to allow for gas from the annulus 360 to enter the production line 380, which may include a separate line to allow for the exiting of gas from the annulus 360, removing it from the well 350.

The head unit controller 420 may use sound wave data received from head unit 100 to determined values for various aspects of the well 350. The head unit controller 420 may filter the sound wave data, which may be received, for example, once every 15 seconds, and then analyze the filtered sound wave data to determine values for the various aspects of the well 350 in real-time. The determined aspects of the well may be, for example, pressure of input to the pump (PIP), fluid over the pump (FOP), pressure flowing at the bottom of the well (PWF), level of fluid free of gas on the pump (FGL), the dynamic level of fluid (DLF), analyzation of the water that makes up the water cut by temperature, the curve of influx of the well (IPR), among other aspects of the well. The fluid over the pump may be the level of fluid, such as oil, water, or a mixture thereof, that covers the pump, and may be determined based on the sound wave data captured during the rebounding of the sound wave. The other aspects of the well may be determined based on any suitable data, including, for example, temperature and pressure data from the dual sensor 210 of the pressure control system 200 well as sound wave data captured during the rebounding of the sound wave within the well 350.

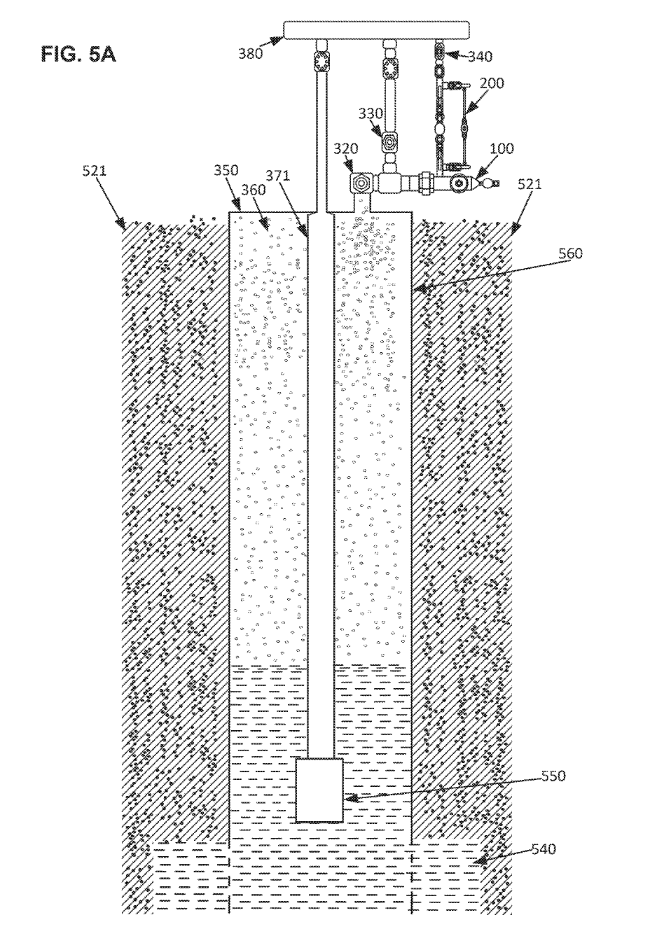

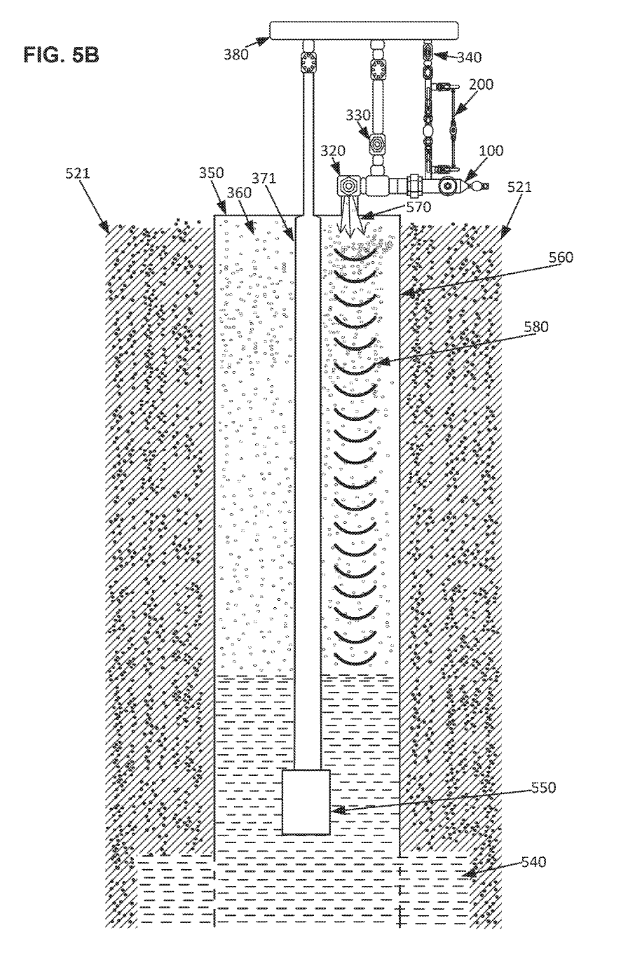

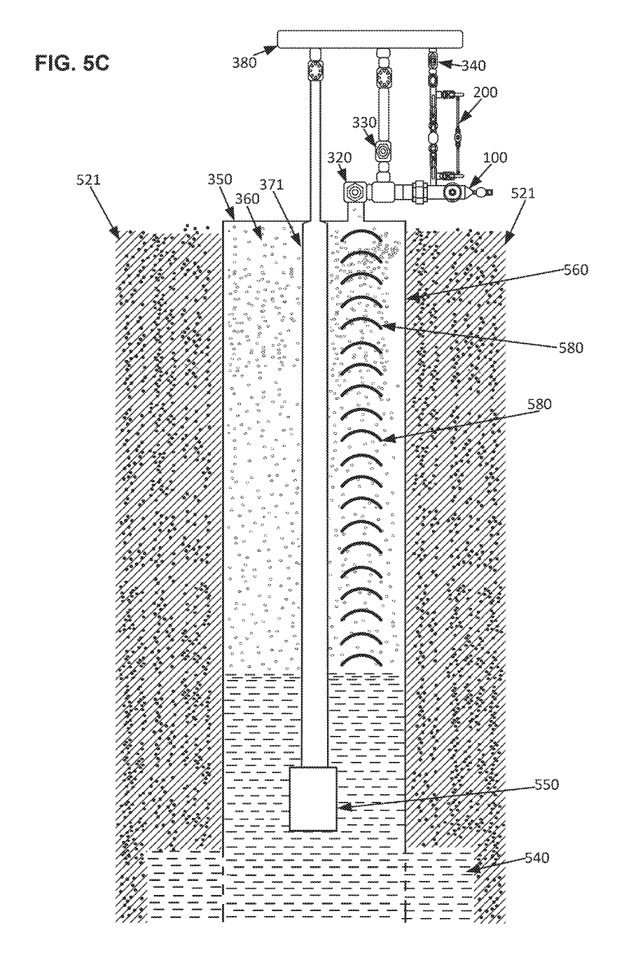

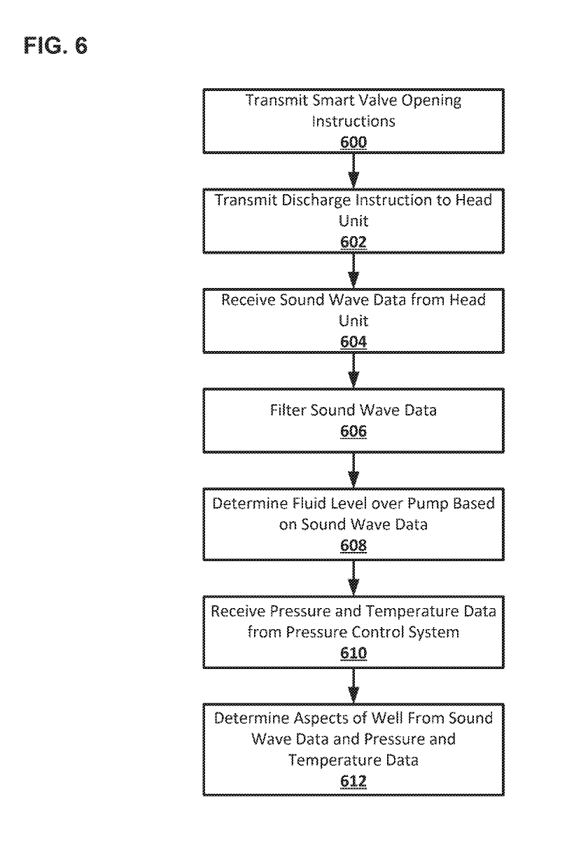

FIG. 5A shows an exemplary system in accordance with the disclosed subject matter. The well 350 may be, for example, a production oil well in the ground 521. The annulus 360 of the well 350 may be between a casing 560 and the production tubing 371. A pump 550 may be attached to the production tubing 371 towards the bottom of the well 350. The pump 550 may be, for example, a progressive cavity pump, a mechanical pump, or an electro-submersible pump. Fluid 540 may enter the well 350 through the casing 560, and may cover the pump 550. The fluid 540 may be, for example, a mixture of oil, water, and other substances. The production tubing 371 may be connected to the production line 380 on the surface.

Free gas may rise up in the annulus 360 of the well 350. The gas may be produced within the well 350 from the fluid 340, or may enter the well 350 from the surrounding ground 521 along with the fluid 340. The smart valve 320 may control the exit of the gas from the annulus 360 of the well 350. For example, when the smart valve 320 is closed, the gas may remain within the annulus 360, and the pressure of the gas within the annulus 360 may rise within the annulus 360 as additional gas is produced or enters the annulus 360. When the smart valve 320 is opened, gas may exit the annulus 360 and flow to the head unit 100, where it may be compressed in a chamber attached to the head unit 100. The gas may also flow to the pressure control system 200, where the dual sensor 210 may be able to read the temperature and pressure of the gas. When the smart valve 320 and the smart valve 330 are opened, the gas may flow to the production line 380, where it may enter a separate line that may be used to discharge or exit gas from the well, reducing the pressure of the gas within the annulus 360. When the smart valve 320, 330, and 330 are all open, some of the gas that has entered the production line 380 may flow to the pressure control system 200 before being exited, and the dual sensor 210 may measure the pressure and temperature of the gas.

FIG. 5B shows an exemplary system in accordance with the disclosed subject matter. To measure the level of the fluid 540 within the well 350, for example, to determine how far the level of the fluid 540 is over the pump 550, the head unit 100 may discharge gas into the well 350. For example, the head unit controller 420 of the computing device 100 may issue a command to the head unit 100 and/or smart valve 320 which may cause gas from the annulus 360 that was compressed in the chamber attached to the head unit 100 to be discharged back into the annulus 360. Only a small amount of gas may be discharged back into the annulus 360. Discharged gas 570 may cause a sound wave 580 to propagate through the gas within the annulus 360 down to the fluid 540. The sound wave 580 may also rebound off the various surfaces within the well 350, including the production tubing 371 and the casing 560.

FIG. 5C shows an exemplary system in accordance with the disclosed subject matter. The sound wave 580 may rebound off of the surface of the fluid 540, and propagate back to the top of the annulus 560, through the smart valve 320, which may be open, and to the head unit 100, where it may be recorded by the microphone 410, generating the sound wave data. The sound wave 580 may also propagate through the fluid 540 and rebound off the bottom of the well 350, then propagate back up to the top of the annulus 560. The microphone 510 may record for any suitable period of time after the discharge of the gas into the annulus 560 by the head unit 100, generating any suitable amount of sound wave data. The sound wave data may be transmitted to the head unit controller 420 of the computing device 400, which may use the sound wave data to determine values for various aspects of the well 350, including, for example, the level of the fluid 540 over the pump 550. Pressure and temperature data from the pressure control system 200 that is contemporaneous with the sound wave data may also be used by the head unit controller 420 in conjunction with the sound wave data when determining values for various aspects of the well 350.

FIG. 6 shows an exemplary procedure in accordance with the disclosed subject matter. At 600, instructions to open a smart valve may be transmitted. For example, the head unit controller 420 of the computing device 400 may generate instructions that may cause the opening of the smart valve 320. The instructions may be transmitted by the computing device 400 in any suitable manner. For example, the computing device 400 may control smart valves through a wired or wireless connection. The instructions, when received by the smart valve 320, may cause the smart valve 320 to open, allowing gas to flow from the annulus 360 to the head unit 100, where it may compress in a chamber attached to the head unit 100.

At 602, a discharge instruction may be transmitted to a head unit. For example, the head unit controller 420 of the computing device 400 may generate instructions that may cause the head unit 100 to discharge a small amount of gas from the chamber back into the annulus 360 to create a sound wave. The instructions may be transmitted by the computing device 400 in any suitable manner. For example, the computing device 400 may control the head unit 100 through a wired or wireless connection. The discharge instruction may also be sent to a smart valve, such as the smart valve 320 or another smart valve, which may need to be opened to allow for gas to reach the annulus 360 from the chamber attached to the head unit 100.

At 604, sound wave data may be received from the head unit. For example, the gas discharged into the annulus 360 may result in the sound wave 580 that propagates through the gas throughout the annulus 360. The sound wave 580 may rebound off of the surface of the fluid 540, and may also rebound off the bottom of the well 350 through the fluid 540, and be detected at the microphone 410 of the head unit 100. The microphone 410 may generate the sound wave data based on the sound wave 580. The sound wave data may be transmitted to the head unit controller 420 of the computing device 400 in any suitable manner. For example, the microphone 410 may be connected to the computing device 400 using any suitable wired or wireless connection, or may be connected to a computing device or other electronics of the head unit 100 which may in turn communicate with the computing device 400 through any suitable wired or wireless connection.

At 606, the sound wave data may be filtered. For example, the head unit controller 420 of the computing device 400 may filter the sound wave data in any suitable manner. The filtering may increase the usability of the sound wave data for determining, for example, the level of the fluid 540 over the pump 550.

At 608, the fluid level over the pump may be determined based on the sound wave data. For example, the head unit controller 420 of the computing device 400 may use the sound wave data, as filtered, to determine the level of the fluid 540 over the pump 550. For example, the sound wave data may be used to calculate the speed of propagation of the sound wave 580 within the well 350. The speed of propagation may then be used to determine the travel time of the sound wave 580, which may be the amount of time taken for the sound wave 580 to rebound off the surface of the top of the fluid 540 in the well 350. The travel time may be used along with the specific gravity of the gas discharged into the annulus 360 to create the sound wave 580 to determine the level of the fluid 540 over the pump 550 in the well 350. The head unit controller 420 of the computing device 400 may use the sound wave data to determine any other suitable aspects of the well 350.

At 610, pressure and temperature data may be received from a pressure control system. For example, the pressure control system controller 430 may receiver pressure and temperature data generated by the dual sensor 210 of the pressure control system 200. The pressure and temperature data may be based on gas that has entered the pressure control system 200 through the head unit 100, or through the production line 380. The pressure and temperature data may be transmitted to the pressure control system controller 420 of the computing device 400 in any suitable manner. For example, the dual sensor 210 may be connected to the computing device 400 using any suitable wired or wireless connection, or may be connected to a computing device or other electronics of the pressure control system 200 which may in turn communicate with the computing device 400 through any suitable wired or wireless connection.

At 612, aspects of the well may be determined based on the sound wave data and the pressure and temperature data. For example, the head unit controller 420 may receive the pressure and temperature data from the pressure control system controller 430. The head unit controller 420 may use the sound wave data and the pressure and temperature data to determine values for various aspects of the well 350, including, for example, pressure of input to the pump (PIP), pressure flowing at the bottom of the well 350 (PWF), level of fluid free of gas on the pump 550 (FGL), the dynamic level of fluid 540 (DLF), an analyzation of the water that makes up the water cut by temperature, and the curve of influx of the well 350 (IPR).

The computing device 400 may control the smart valves, such as the smart valves 320, 330, and 340, and other components, such as the head unit 100 and pressure control system 200, based on the values determined for the various aspects of the well, including the level of the fluid 540 over the pump 550. For example, the head unit controller 420 of the computing device 400 may close the smart valve 320 in order to pressurize gas in the annulus 360 of the well 350, and may control the smart valve 340 between the pressure control system 200 and the production line 380, in order to control and change various aspects of the well. The computing device 400 may control the various smart valves and components based on the values for the aspects of the well in order to increase the output of the well 350.

Embodiments of the presently disclosed subject matter may be implemented in and used with a variety of component and network architectures. FIG. 7 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 8.

Many other devices or components (not shown) may be connected in a similar manner, such as document scanners, digital cameras, auxiliary, supplemental, or backup systems, or the like. Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 8 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
transmitting to a smart valve disposed between an annulus of a well and a head unit an instruction to open;
transmitting to the head unit an instruction to discharge gas into the annulus of the well to generate a sound wave;
receiving, from the head unit, sound wave data generated by a microphone of the head unit based on the sound wave propagated through gas in the annulus of the well;
determining, based on the sound wave data, a level of fluid over a pump in the well.

2. The method of claim 1, further comprising filtering the sound wave data before determining the level of fluid over the pump in the well.

3. The method of claim 1, wherein determining the level of fluid over the pump in the well based on the sound wave data further comprises:
determining a speed of propagation of the sound wave within the well based on the sound wave data;
determining a travel time of the sound wave from the top of the well to a surface of the fluid within the well back to the top of the well based on the speed of propagation of the sound wave; and
determining the level of fluid over the pump in the well based on the travel time and specific gravity of the gas discharged into the annulus of the well.

4. The method of claim 1, further comprising:
receiving pressure and temperature data from a pressure control system; and
determining at least one value for at least one aspect of the well based on the sound wave data and pressure and temperature data.

5. The method of claim 1, wherein the at last one aspect of the well is one of pressure of input to the pump, fluid over the pump, pressure flowing at the bottom of the well, level of fluid free of gas on the pump, analyzation of an amount of water that makes up a water cut by temperature, and a curve of influx of the well.

6. The method of claim 1, further comprising transmitting, to one or more smart valves, at least one instruction to open or close based on the determined level of fluid over the pump in the well.

7. An apparatus comprising:
a head unit comprising a microphone;
a smart valve connected between the head unit and the annulus of a well such that gas flows from the annulus to the head unit when the smart valve is opened and stays in the annulus when the smart valve is closed; and
a chamber connected to the head unit, wherein the head unit is configured to discharge gas from the chamber into the annulus, and wherein the microphone is configured generate sound wave data based on a sound wave generated by a discharge of gas from the chamber into the annulus.

8. The apparatus of claim 7, wherein the head unit is further configured to transmit the sound wave data to a computing device.

9. The apparatus of claim 8, wherein the computing device is configured to determine a level of fluid over a pump in the well based on the sound wave data.

10. The apparatus of claim 7, wherein the smart valve is configured to receive instructions from a computing device, wherein the instructions cause the smart valve to open or close.

11. The apparatus of claim 7, further comprising a pressure control system comprising a dual sensor, the dual sensor comprising a temperature sensor and a pressure sensor, wherein the pressure control system is connected to the head and to a production line of the well, and wherein the dual sensor is configured to generate pressure and temperature data for a gas and the pressure control system is configured to transmit the pressure and temperature data to a computing device.

12. The apparatus of claim 7, wherein the head unit is configured to discharge the gas from the chamber into the annulus of the well in response to receiving a discharge instruction from a computing device.

13. A method comprising:
receiving an instruction to discharge gas into an annulus of a well;
discharging the gas into the annulus of the well;
recording a sound wave caused by the discharging of the gas into annulus the well and propagated through gas within the annulus of the well with a microphone to generate sound wave data; and
transmitting the sound wave data to a computing device.

14. The method of claim 13, wherein discharging gas into the annulus of the well comprises opening at least one smart valve.

15. The method of claim 14, wherein the at least one smart valve is connected between a chamber and the annulus of the well.

16. A system comprising: one or more computers and one or more storage devices storing instructions which are operable, when executed by the one or more computers, to cause the one or more computers to perform operations comprising:
transmitting to a smart valve disposed between the annulus of a well and a head unit an instruction to open;
transmitting to the head unit an instruction to discharge gas into the annulus of the well;
receiving from the head unit sound wave data generated by a microphone of the head unit based on a sound wave propagated through gas in the annulus of the well;
determining, based on the sound wave data, a level of fluid over a pump in the well.

17. The system of claim 16, wherein the instructions which are operable, when executed by the one or more computers, further cause the one or more computers to perform operations comprising:
filtering the sound wave data before determining the level of fluid over the pump in the well.

18. The system of claim 16, wherein the instructions which are operable, when executed by the one or more computers, further cause the one or more computers to perform operations to determine the level of fluid over the pump in the well based on the sound wave data comprising:
determining a speed of propagation of the sound wave within the well based on the sound wave data;
determining a travel time of the sound wave from the top of the well to a surface of the fluid within the well back to the top of the well based on the speed of propagation of the sound wave; and
determining the level of fluid over the pump in the well based on the travel time and specific gravity of the gas discharged into the annulus of the well.

19. The system of claim 16, wherein the instructions which are operable, when executed by the one or more computers, further cause the one or more computers to perform operations comprising:
receiving pressure and temperature data from a pressure control system; and
determining at least one value for at least one aspect of the well based on the sound wave data and pressure and temperature data.

20. The system of claim 16, wherein the instructions which are operable, when executed by the one or more computers, further cause the one or more computers to perform operations comprising:
transmitting, to one or more smart valves, at least one instruction to open or close based on the determined level of fluid over the pump in the well.
